(19) United States
(12) Patent Application Publication
(10) Pub. No.: US 2016/0105431 A1
(43) Pub. Date: Apr. 14, 2016

(54) METHOD OF PROVIDING SNS-GROUP INVITING SERVICE AND SNS SERVER THEREFOR

(71) Applicant: Samsung Electronics Co., Ltd., Gyeonggi-do (KR)

(72) Inventors: Tae-ho WANG, Gyeonggi-do (KR); Sin-oug YEO, Seoul (KR); Eun-kyung YOO, Seoul (KR); O-hoon KWON, Gyeonggi-do (KR); Su-hyun NAM, Gyeonggi-do (KR); Sung-bin IM, Gyeonggi-do (KR)

(21) Appl. No.: 14/975,050

(22) Filed: Dec. 18, 2015

Related U.S. Application Data
(63) Continuation of application No. 13/614,319, filed on Sep. 13, 2012.

(30) Foreign Application Priority Data
Dec. 9, 2011 (KR) 10-2011-0132132

(51) Int. Cl. H04L 29/06; G06F 21/44; H04L 12/58

(52) U.S. Cl. CPC H04L 63/0853; H04L 51/32; G06F 21/44

(57) ABSTRACT

A method for registering a device to a server is provided. The method includes connecting a first device to a second device, the first device having been registered to the server; receiving, by the first device, device information of the second device from the second device; transmitting, by the first device, the device information of the second device to the server; receiving, by the first device, information for authentication of the second device based on the device information of the second device from the server; and transmitting, if the information for authentication of the second device is received, the information for authentication of the second device to the second device.

### PRIORITY

This application is a continuation of U.S. patent application Ser. No. 13/614,319, filed on Sep. 13, 2012, and claims priority to Korean Patent Application No. 10-2011-0132132, filed on Dec. 9, 2011, in the Korean Intellectual Property Office, the contents of which are incorporated herein by reference.

### BACKGROUND OF THE INVENTION

1. Field of the Invention

The present invention relates generally to a Social Networking Service (SNS), and more particularly, to a method of providing an SNS-group inviting service, which provides services for inviting and joining a device to an SNS group by using authentication information, and an SNS server therefor.

2. Description of the Related Art

FIG. 1 illustrates a conventional method of providing a service for joining an SNS group.

Referring to FIG. 1, generally, in order to join an SNS group, a user accesses an SNS group service server via a wired or wireless communication device in step S10. When the user logs in using a predetermined account in step S20, the user confirms an invitation list via the wired or wireless communication device and selects a predetermined group in step S70, and accepts an invitation in step S80.

When the user is not logged in via the account or does not have any account in step S30, the user inputs information required to create an account in step S40 and performs a process for creating the account in step S50. For example, the user needs to input a variety of information such as a phone number, an address, and a hobby as well as basic information including a name, a resident registration number, an account IDentifier (ID), or a password (which may include a word), in order to generate the account.

That is, in order to use an SNS group service, the user needs to create an account and needs to input a large amount of information in order to create the account. Thus, when a user who is invited to an SNS group is an elderly person who may not be accustomed to manipulating a device or has a device that causes inconvenience with respect to character input, use of an SNS group service becomes limited. Thus, there is a need for a system for allowing a user who is invited to an SNS group to use an SNS group service by simpler manipulation.

### SUMMARY OF THE INVENTION

According to an aspect of the present invention, a method for registering a device to a server is provided. The method includes connecting a first device to a second device, the first device having been registered to the server; receiving, by the first device, device information of the second device from the second device; transmitting, by the first device, the device information of the second device to the server; receiving, by the first device, information for authentication of the second device based on the device information of the second device from the server; and transmitting, if the information for authentication of the second device is received, the information for authentication of the second device to the second device.

According to another aspect of the present invention, a method for registering a device to a server is provided. The method includes receiving, by the server, device information of a second device from a first device, the first device having been registered to the server; transmitting, if the device information of the second device is received, first information for authentication of the second device to the second device; receiving second information for authentication of the second device from the second device; comparing the first information with the second information; and registering the second device in association with the first device if the first information corresponds to the second information.

According to another aspect of the present invention, a method for registering a device to a server is provided. The method includes connecting a second device to a first device, the first device having been registered to the server; transmitting, by the second device, device information of the second device to the first device; receiving first information for authentication of the second device based on the device information of the second device from the server; and transmitting second information for authentication of the second device to the server if the first information for authentication of the second device is received.

### BRIEF DESCRIPTION OF THE DRAWINGS

The above and other features and advantages of the present invention will become more apparent by describing in detail embodiments thereof with reference to the attached drawings in which:

FIG. 1 illustrates a conventional method of providing a service for joining an SNS group;

FIG. 2 illustrates a system for providing an SNS group inviting service, according to an embodiment of the present invention;

FIG. 3 illustrates an SNS server for providing a SNS-group inviting service, according to an embodiment of the present invention;

FIG. 4 is a block diagram of a SNS server according to another embodiment of the present invention;

FIG. 5 illustrates a method of providing an SNS-group inviting service, according to an embodiment of the present invention;

FIG. 6 illustrates a method of providing an SNS-group inviting service, according to an embodiment of the present invention;

FIG. 7 illustrates a method of providing an SNS group service based on an identification value of the second device, according to an embodiment of the present invention;

FIG. 8 illustrates a screen for inviting a device to an SNS group, according to an embodiment of the present invention;

FIG. 9 illustrates a screen of an SNS group joining request based on authentication information, according to an embodiment of the present invention;

FIG. 10 illustrates a screen of an authentication information list, according to an embodiment of the present invention; and

FIG. 11 illustrates a screen of an invitation request group list, according to an embodiment of the present invention.

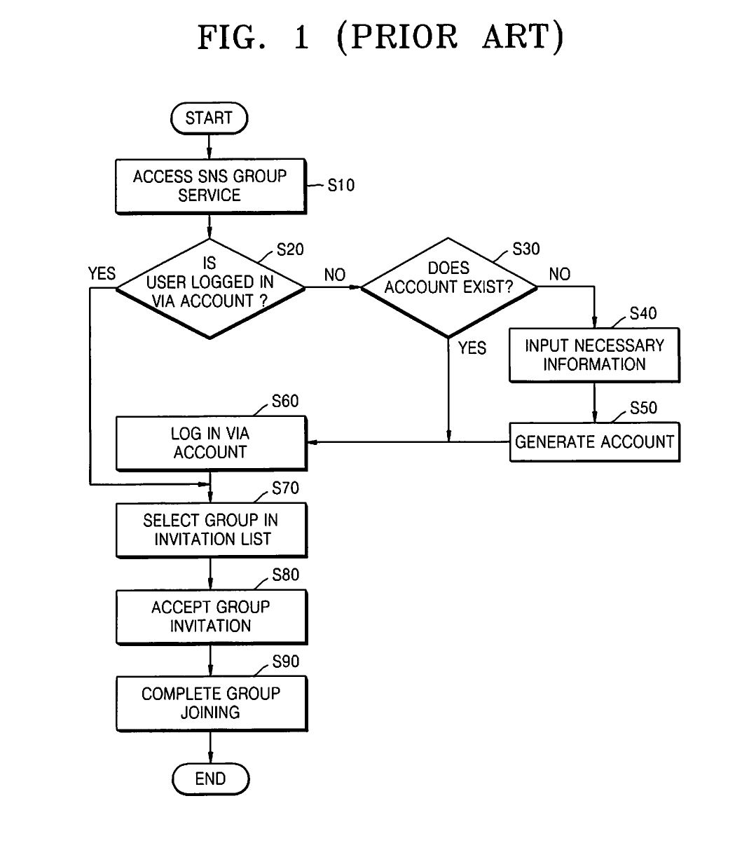

### DETAILED DESCRIPTION OF THE INVENTION

Embodiments of the present invention will be described herein below with reference to the accompanying drawings. In the following description, well-known functions or constructions are not described in detail for the sake of clarity and conciseness.

In the present specification, it should be understood that terms such as ‘including’ or ‘having,’ etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, terms such as ‘unit’ or ‘module’ should be understood as a unit that processes at least one function or operation and that may be embodied in a hardware manner, a software manner, or a hardware and software combination.

Throughout the specification, the term ‘Social Networking Service (SNS)’ refers to a service for allowing users to interact with unspecified people online. Users make more personal connections or reinforce existing personal connections via an SNS. In addition, throughout the specification, the term ‘SNS group’ refers to a group that is generated between SNS users. According to the present invention, in order to join an SNS group, a process of registering an account and a device identification value with a server is required.

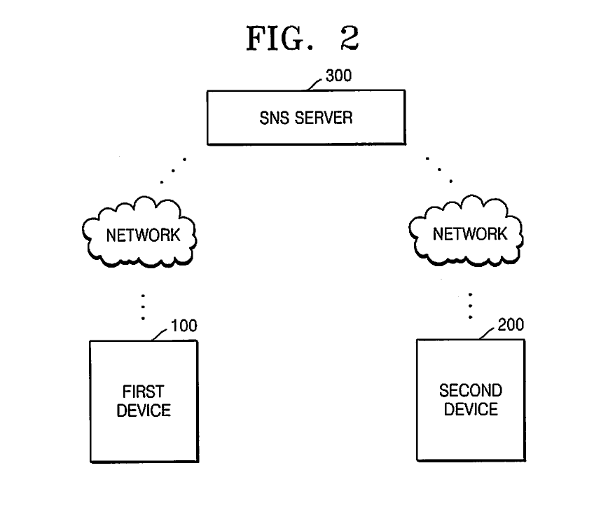

FIG. 2 illustrates a system for providing an SNS group inviting service, according to an embodiment of the present invention.

Referring to FIG. 2, the system according to the present embodiment may include a first device 100, a second device 200, and an SNS server 300.

The first device 100 may be a device of a first user who has a right to invite another user or another device to an SNS group. The second device 200 may be a device of a second user who receives an SNS group invitation request from the first user. That is, according to the present embodiment, the first user may invite the second user or the second device 200 to the SNS group via the first device 100.

The first user and the second user may be the same user. That is, the first user may use the first device 100 in order to allow the second device 200, which causes inconvenience with respect to inputting characters thereto, to join the SNS group.

The first device 100 is embodied in various forms, such as a desktop computer, a cellular phone, a smart phone, a laptop computer, a terminal for digital broadcast, a Personal Digital Assistant (PDA), a Portable Multimedia Player (PMP), a navigation device, a tablet Personal Computer (PC), an MP3 player, a digital camera, or a Consumer Electronics (CE) device.

The first device 100 performs wired or wireless communication with the SNS server 300. Thus, the first device 100 requests the SNS server 300 to invite the second user or the second device 200 to the SNS group. When the first device 100 makes the request for invitation to the SNS group, the first device 100 transmits second-user identification information, and SNS group information, to the SNS server 300.

In addition, the first device 100 receives authentication information in response to the SNS group invitation request, from the SNS server 300.

The authentication information refers to information that is used to permit a user or a device to join a group. The authentication information may correspond to a word, a number, or a combination thereof, such as an authentication number of which ciphers are predetermined and may have an expiration date.

The authentication information may correspond to a single-use authentication number that is used once.

The first device 100 transmits a message to the second device 200, such as through a mobile communication network, a wired network, or the Internet.

The second device 200 may be embodied in various forms, such as a desktop computer, a cellular phone, a smart phone, a laptop computer, a terminal for digital broadcast, a PDA, a PMP, a navigation device, a tablet PC, an MP3 player, a digital camera, or a CE device.

In particular, the second device 200 may include a CE device such as a Digital Television (DTV), an Internet Protocol Television (IPTV), and a refrigerator and an air conditioner, which have a display device.

The second device 200 performs wired or wireless communication with the SNS server 300. For example, the second device 200 transmits the SNS group joining request containing the authentication information to the SNS server 300.

The second device 200 obtains the authentication information from the first device 100 or the SNS server 300.

The second device 200 transmits an identification value of the second device 200 to the SNS server 300 and receives an available service in the SNS group from the SNS server 300 through wired or wireless communication.

The SNS server 300 is for providing a social networking service. The SNS server 300 provides an SNS-group inviting service to the first device 100 or the second device 200. The SNS-group inviting service refers to a service for allowing the first user who previously joins an SNS group to simply invite another user or another device to the SNS group.

The SNS server 300 performs wired or wireless communication with the first device 100 and the second device 200. Thus, the SNS server 300 provides the SNS group to the first device 100 or the second device 200. The SNS group service refers to a service that is embodied to have various types in order to allow a plurality of users to share information or to communicate in the SNS group.

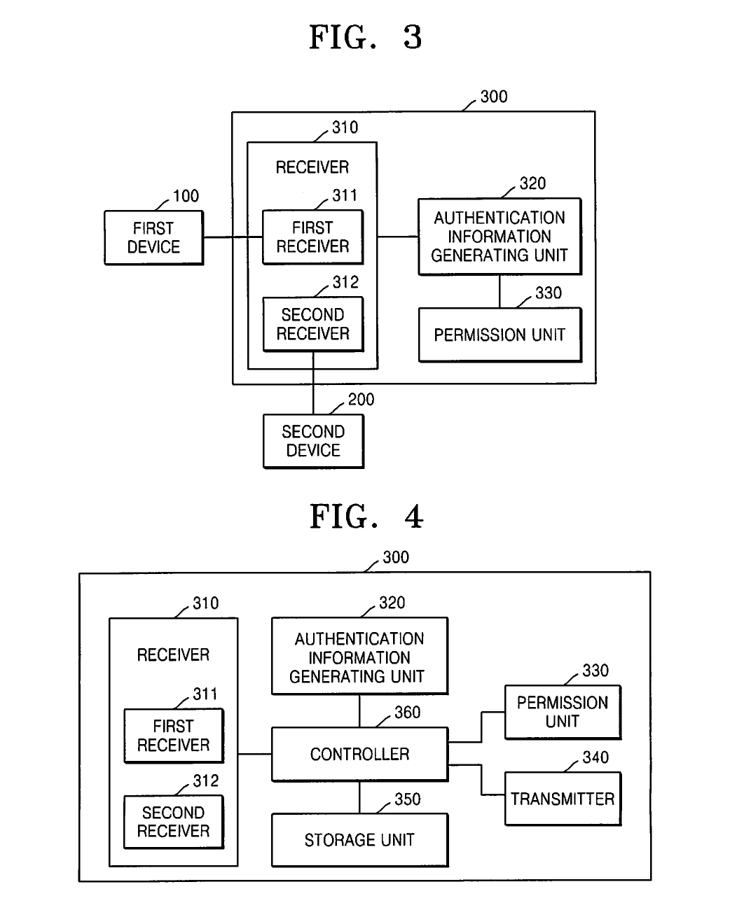

FIG. 3 illustrates an SNS server 300 for providing a SNS-group inviting service, according to an embodiment of the present invention.

As shown in FIG. 3, the SNS server 300 includes a receiving unit 310, an authentication information-generating unit 320, and a permission unit 330. However, not all of the elements shown in FIG. 3 may be necessary. The SNS server 300 may be embodied by additional elements to those shown in FIG. 3 or may be embodied by fewer elements than those shown in FIG. 3.

The receiving unit 310 receives data from the first device 100 or the second device 200 through wired or wireless communication.

The receiving unit 310 includes a first receiver 311 for receiving data from the first device 100 and a second receiver 312 for receiving data from the second device 200. The first receiver 311 and the second receiver 312 may be embodied as a single module or as separate modules.

The first receiver 311 receives the SNS group invitation request containing the second-user identification information from the first device 100 of the first user.

The second receiver 312 receives the SNS group joining request containing second authentication information from the second device 200 of the second user. That is, the second user may accept SNS group invitation by inputting the second authentication information to the second device 200.

The second receiver 312 receives the identification value of the second device 200 from the second device 200. The term ‘identification value of the second device 200’ refers to unique information for identifying the second device 200 and includes a device ID, a unique serial number, a Media Access Control (MAC) address, and an International Mobile Equipment Identity (IMEI).

The second receiver 312 receives the second-user identification information from the second device 200. The second-user identification information refers to information for identifying the second user who is to be invited to the SNS group by the first user.

According to the present invention, the term ‘second-user identification information’ may contain, but is not limited to, an ID, a nickname, a phone number, and a resident registration number of the second user.

The authentication information-generating unit 320 generates first authentication information corresponding to the second-user identification information in response to the SNS group invitation request that is received from the first device 100. That is, first authentication information may be generated for respective identification information of the user. Thus, when there are pieces of second-user identification information, the authentication information-generating unit 320 generates the first authentication information that corresponds to the pieces of second-user identification information.

The authentication information-generating unit 320 generates the authentication information based on at least one of the second-user identification information and group information. Alternatively, the authentication information-generating unit 320 may randomly generate the first authentication information.

The authentication information-generating unit 320 sets an expiration date of the first authentication information. For example, the authentication information-generating unit 320 sets a period of time when the second device 200 is capable of being invited by using the first authentication information as one month. When one month passes after the first authentication information is generated, the first user needs to request the SNS server 300 to generate the authentication information again in order to invite the second device 200.

The permission unit 330 compares the first authentication information generated by the authentication information-generating unit 320 and the second authentication information received from the second device 200 with each other and selectively permits the second device 200 to join the SNS group.

For example, when the first authentication information and the second authentication information correspond to each other, the permission unit 330 permits the second device 200 to join the SNS group and issues an access token of the SNS group to the second device 200.

If the first authentication information and the second authentication information do not correspond to each other, the permission unit 330 may request the second device 200 for new second authentication information several times or may deny the second device 200 permission to join the SNS group.

When the permission unit 330 permits the second device 200 to join the SNS group, the second-user identification information and the identification value of the second device 200 may be mapped to each other and may be stored.

FIG. 4 illustrates a SNS server 300 according to another embodiment of the present invention.

Referring to FIG. 4, the SNS server 300 further includes a transmitter 340, a storage unit 350, and a controller 360 in addition to the receiving unit 310, the authentication information-generating unit 320, and the permission unit 330.

The transmitter 340 generates the first authentication information generated by the authentication information-generating unit 320 to the first device 100. The first authentication information may be transmitted to the second device 200 through the first device 100.

The transmitter 340 transmits the first authentication information generated by the authentication information-generating unit 320.

When the first receiver 311 receives, for example, a cellular phone number or an e-mail address of the second user together with the SNS group invitation request, from the first device 100, the transmitter 340 transmits the first authentication information to the second device 200, based on such information as the cellular phone number and the e-mail address of the second user.

The transmitter 340 provides the authentication information list to the first device 100. The authentication information list refers to a list containing pieces of first authentication information corresponding to pieces of second-user identification information.

That is, when the first user wants to invite a plurality of second users, the first user transmits SNS group invitation requests that respectively correspond to pieces of the second-user identification information, to the SNS server 300. The SNS server 300 generates pieces of first authentication information that respectively correspond to the pieces of second-user identification information. In addition, when the receiving unit 310 receives a request for an authentication information list from the first device 100, the transmitter 340 transmits the authentication information list to the first device 100.

The transmitter 340 provides an invitation request group list corresponding to the second-user identification information received from the second device 200, to the second device 200. According to the present invention, the term ‘invitation request group’ refers to an SNS group that generates an authentication number and invites the second user.

For example, when a group A and a group B respectively generate an authentication number a and an authentication number b, which are related to second-user identification information ‘XX’, and transmits a SNS group invitation request to the second user, the transmitter 340 transmits information about the group A and the group B that transmit the SNS group invitation request to the second user in a list form to the second device 200.

The transmitter 340 provides detailed information about the invitation request group corresponding to the second-user identification information received from the second device 200, to the second device 200. The detailed information of the ‘invitation request group’ may include group master information, a group name, group activity information, and popularity.

The transmitter 340 provides the SNS group service to the second device 200 when the second device 200 is permitted to join the SNS group.

For example, when the identification value of the second device 200 is received from the second device 200, the transmitter 340 provides the SNS group service corresponding to the received identification value of the second device 200, to the second device 200.

Thus, when the second device 200 is permitted to join the SNS group, the second user may use the SNS group service through the identification value of the second device 200 without a login process.

When the first authentication information corresponding to the identification information of the second user is generated in response to the SNS group invitation request received from the first device 100, the storage unit 350 maps the first authentication information and the second-user identification information to each other and stores the first authentication information.

In addition, when the second device 200 is permitted to join the SNS group, the storage unit 350 maps and stores the second-user identification information and the identification value of the second device 200 together. Thus, even though the second user accesses the SNS server 300 through the second device 200 without having to login by using a separate account, the second user may communicate with another user in the SNS group, based on the second-user identification information.

The storage unit 350 stores detailed information (e.g., a group name, group master information, information about group members, group activity information, and group popularity) about an SNS group, first user information, second user information, etc.

The controller 360 generates an authentication information list of the first device 100, based on a plurality of SNS group invitation requests received from the first device 100. That is, when a plurality of second users or the plurality of SNS group invitation requests of the second device 200 are received from the first device 100 of the first user, the controller 360 generates the authentication information list corresponding to a plurality of pieces of second-user identification information.

In addition, the controller 360 controls the overall operations of the receiving unit 310, the authentication information-generating unit 320, the permission unit 330, the transmitter 340, and the storage unit 350.

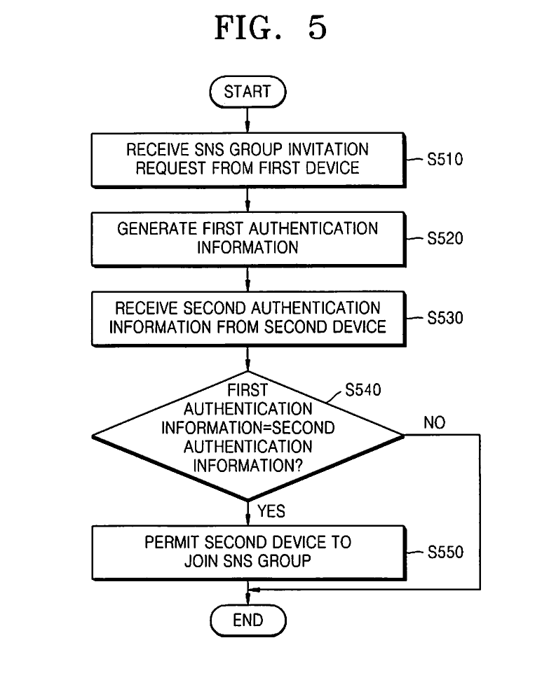

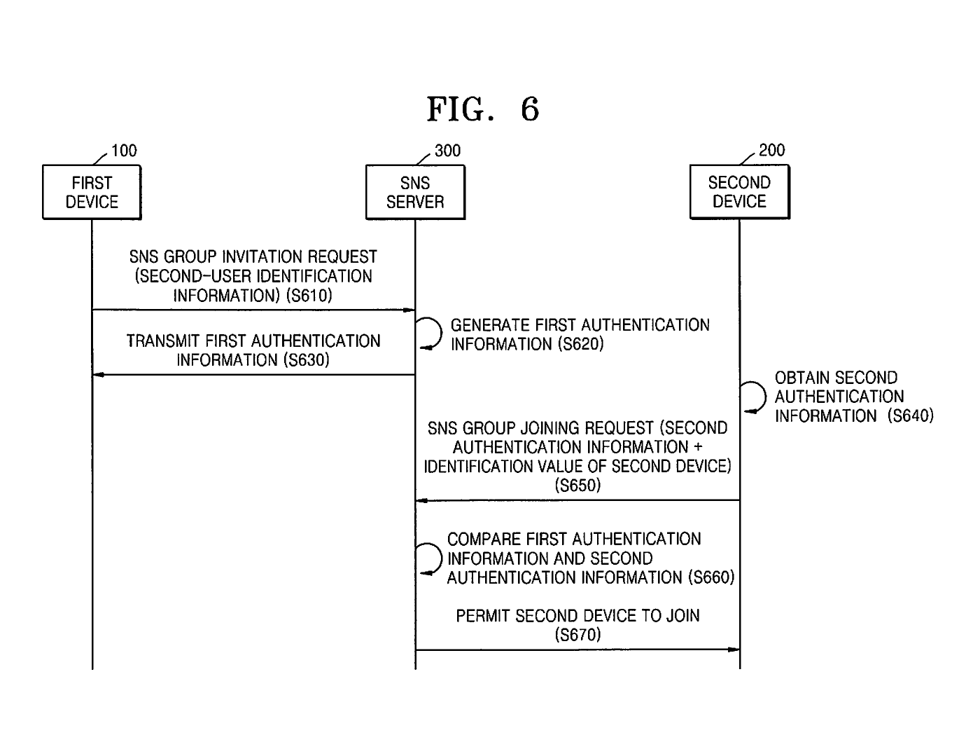

FIGS. 5 and 6 illustrate a method of providing an SNS-group inviting service, according to embodiments of the present invention.

Referring to FIGS. 5 and 6, the method includes operations that are performed by the SNS server 300 of FIGS. 3 and 4 in a time sequence. Thus, although omitted, the detailed description of the SNS server 300 shown in FIGS. 3 and 4 are applied to the method of providing the SNS-group inviting service shown in FIGS. 5 and 6.

As shown in FIGS. 5 and 6, the SNS server 300 receives an SNS group invitation request including the second-user identification information, from the first device 100 of the first user in step S510 and S610. The term ‘SNS group invitation request’ refers to when the first user requests the SNS server 300 to generate authentication information in order to invite the second user to an SNS group.

The first user inputs identification information of the second user that is to be invited by the first user via the first device 100 and transmits the SNS group invitation request to the SNS server 300.

In this case, the SNS server 300 generates the first authentication information corresponding to the second-user identification information in response to the SNS group invitation request in step S520 and S620. The first authentication information may correspond to a number of predetermined ciphers, such as four ciphers.

In addition, the first authentication information may be a value that is generated based on at least one of the second-user identification information and the SNS group information or a random value.

The SNS server 300 transmits the generated first authentication information to the first device 100 or the second device 200 in step S630.

If the SNS server 300 transmits the first authentication information to the first device 100, the first user may orally notify the second user about the first authentication information. Alternatively, the first user may notify the second user about the first authentication information by using a text message, an e-mail, a messenger service, etc.

That is, the second user obtains the first authentication information from the first user and obtains the first authentication information from the SNS server 300 in step S640.

When the second user transmits the obtained authentication information to the SNS server 300 via the second device 200, the second user may simultaneously transmit the SNS group joining request to the SNS server 300. That is, the SNS server 300 receives the SNS group joining request including the second authentication information from the second device 200 of the second user in steps S530 and S650.

In this case, the SNS server 300 may further receive the identification value of the second device 200 from the second device 200.

The SNS server 300 compares the generated first authentication information and the second authentication information with each other and confirms whether the generated first authentication information corresponds to the second authentication information received from the second device 200 in steps S540 and S660.

Since the second user obtains the first authentication information from the first user or the SNS server 300, the second authentication information that is transmitted to the SNS server 300 via the second device 200 by the second user needs to correspond to the first authentication information.

The SNS server 300 selectively permits the second device 200 to join the SNS group according to the comparison result in steps S550 and S670. That is, when the first authentication information corresponds to the second authentication information, the SNS server 300 permits the second device 200 to join the SNS group. When the first authentication information does not correspond to the second authentication information, the SNS server 300 does not permit the second device 200 to join the SNS group.

When the second device 200 is permitted to join the SNS group, the SNS server 300 maps and stores the second-user identification information and the identification value of the second device 200 to each other.

Thus, even if the second user inputs only authentication information, the second device 200 is capable of joining the SNS group, thereby improving user convenience. In particular, the present invention improves the instances when the second device 200 is a television, which would typically cause inconvenience with respect to having to input characters therein, or when the second user is not accustomed to manipulating a device.

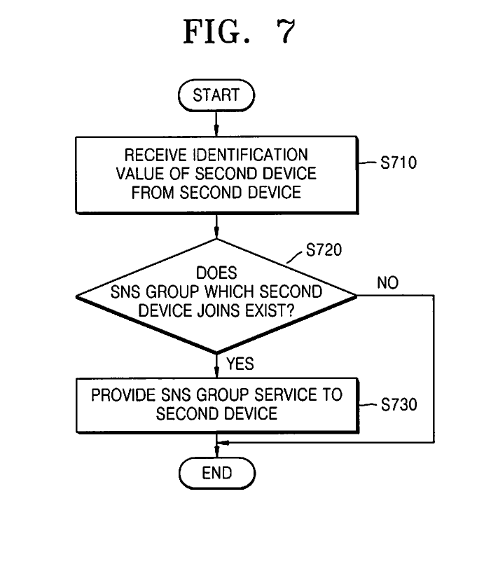

FIG. 7 illustrates a method of providing an SNS group service based on an identification value of the second device 200, according to an embodiment of the present invention.

When a process in which the second device 200 joins the SNS group is completely performed, the second user accesses the SNS server 300 via the second device 200 in order to use services provided from the SNS group that the second user joins.

In this case, the SNS server 300 receives the identification value of the second device 200 from the second device 200 in step S710. The identification value of the second device 200 may include an ID of the second device 200, a MAC address, an IMEI, etc.

The SNS server 300 determines whether there is an SNS group that the second device 200 joins, based on the identification value of the second device 200 in step S720.

For example, when a process in which the second device 200 joins the SNS group is completely performed, since the SNS server 300 maps the second-user identification information about the SNS group and the identification value of the second device 200 to each other and stores the second-user identification information and the identification value of the second device 200 in the storage unit 350, the SNS server 300 determines whether the identification value of the second device 200, which is received from the second device 200, is stored in the storage unit 350.

When there is an SNS group that the second device 200 joins, the SNS server 300 provides an available service in the SNS group that the second device 200 joins, to the second device 200 in step S730. For example, the SNS group service may include an information-sharing service, a writing service, an inviting service, a messaging service, etc.

When there is a plurality of SNS groups that the second device 200 joins, the SNS server 300 may provide a list of a plurality of SNS groups that the second device 200 joins, to the second device 200.

When a process in which the second device 200 joins the SNS group is completely performed, the second user simply uses the SNS group service via the second device 200 without a complicated login process.

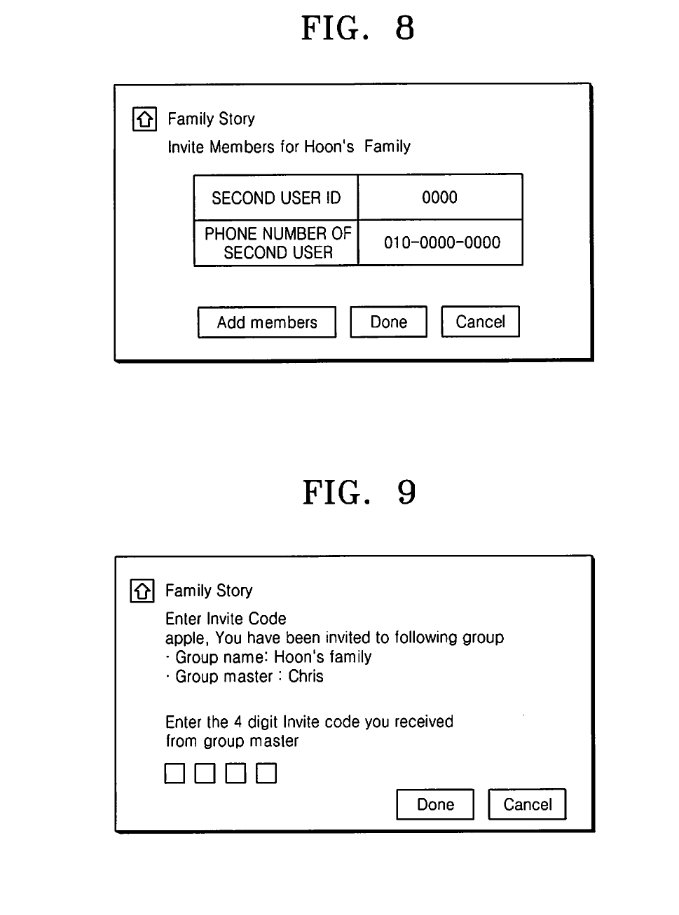

FIG. 8 illustrates a screen for inviting a device to an SNS group, according to an embodiment of the present invention.

As shown in FIG. 8, according to an embodiment of the present invention, the user inputs the second-user identification information via the first device 100 and requests the SNS server 300 to generate authentication information corresponding to the second-user identification information so as to allow the second device 200 of the second user to join an SNS group.

The first user inputs an ID (e.g., OOOO) of the second user or a phone number (e.g., 010-0000-0000) of the second user, as the second-user identification information. When the first user inputs the phone number of the second user, the SNS server 300 may transmits the first authentication information directly to the second device 200 by using the phone number of the second user.

FIG. 9 illustrates a screen of an SNS group joining request based on authentication information, according to an embodiment of the present invention.

Referring to FIG. 9, the second user transmits the second-user identification information to the SNS server 300 via the second device 200 and simultaneously requests the SNS server 300 for detailed information about the invitation request group. The SNS server 300 transmits the detailed information about the invitation request group, which corresponds to the second-user identification information, to the second device 200.

For example, the second device 200 transmits an ID ‘apple’ of the second user to the SNS server 300 and simultaneously requests the SNS server 300 for the detailed information about the invitation request group. For example when Hoon's family requests the SNS server 300 to invite the second user to Hoon's family by using the authentication information, the SNS server 300 provides detailed information (e.g., a group name: Hoon's family, a group master: Chris, etc.) about Hoon's family to the second device 200.

When the second user wants to join Hoon's family, the second user transmits the authentication information corresponding to Hoon's family to the SNS server 300 such that the second device 200 may join Hoon's family.

Then, the second user simply uses services of Hoon's family via the second device 200 without having to login.

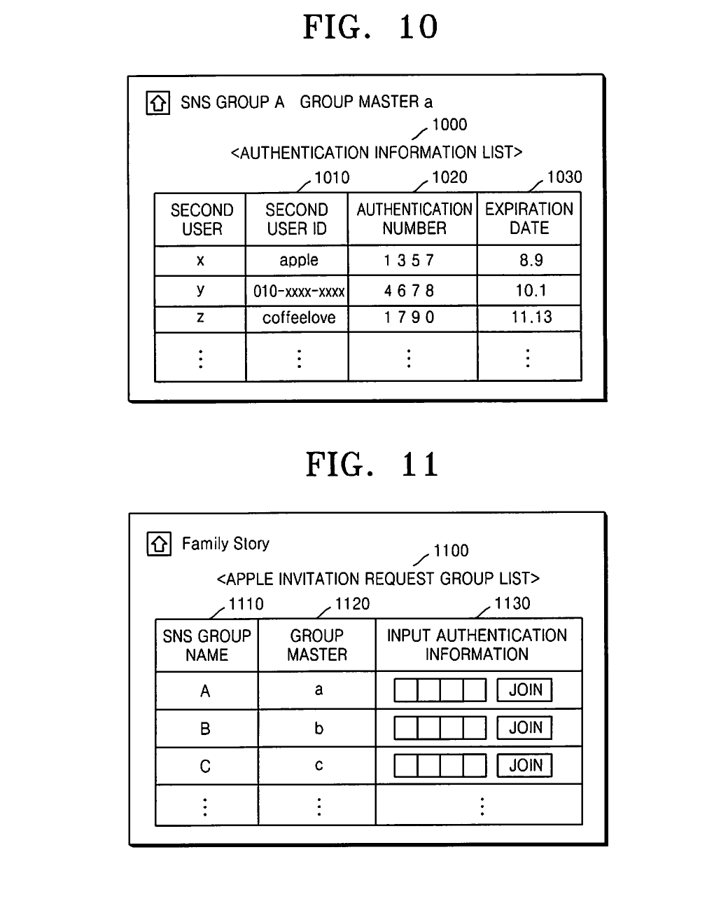

FIG. 10 illustrates a screen of an authentication information list 1000, according to an embodiment of the present invention.

As shown in FIG. 10, the user requests the SNS server 300 for the authentication information list 1000 via the first device 100. In this case, the SNS server 300 provides the authentication information list 1000 about the first device 100, which is generated based on a plurality of SNS group invitation requests received from the first device 100.

For example, the first user may be a group master ‘a’ of an SNS group A. In this case, the SNS server 300 provides the authentication information list 1000 that is transmitted from the SNS server 300 to the group master ‘a’ in order to invite the second user to the SNS group A, to the first device 100.

The authentication information list 1000 about the first device 100 includes second-user identification information 1010, a first authentication number 1020 corresponding to the second-user identification information, expiration data information 1030 of the first authentication information, etc.

Thus, the first user may confirm the authentication information list 1000 and may notify the second user about the generated first authentication information again.

FIG. 11 illustrates a screen of an invitation request group list 1100, according to an embodiment of the present invention.

As shown in FIG. 11, when the second user is invited to a plurality of SNS groups, the SNS server 300 provides the invitation request group list 1100 corresponding to the second-user identification information to the second device 200.

For example, it is assumed that authentication information corresponding to second-user identification information ‘apple’ is issued by the SNS server 300 in order for a group A, a group B, and a group C to invite the second user to the group A, the group B, and the group C themselves. In this case, the SNS server 300 provides a list of the group B, and the group C that transmit the group invitation request for the ‘apple’ based on the authentication information, to the second device 200.

When the second user wants to join the group A, the second user inputs the authentication information, which is obtained from the group master ‘a’ or the SNS server 300, so as to join the second device 200.

The invitation request group list 1100 includes an SNS group name 1110, a group master 1120, and an authentication information input window 1130, etc.

Thus, since the second device 200 of the second user joins a SNS group by simply inputting authentication information to the second device 200, although a user who is invited to an SNS group may, for example, be elderly and may not be accustomed to manipulating a device or has an inconvenient character input device, the user may easily use SNS group services.

Embodiments of the present invention can include a non-transitory computer readable medium including program commands for executing operations implemented through various computers. The computer readable medium can store program commands, data files, data structures or combinations thereof. The program commands recorded in the medium may be specially designed and configured for the present invention or be known to those of ordinary skill in the field of computer software. Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code created by a compiler and a high-level language code executable by a computer using an interpreter, etc.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A method for registering a device to a server, the method comprising:
connecting a first device to a second device, the first device having been registered to the server;
receiving, by the first device, device information of the second device from the second device;
transmitting, by the first device, the device information of the second device to the server;
receiving, by the first device, information for authentication of the second device based on the device information of the second device from the server; and
transmitting, if the information for authentication of the second device is received, the information for authentication of the second device to the second device.

2. A method for registering a device to a server, the method comprising:
receiving, by the server, device information of a second device from a first device, the first device having been registered to the server;
transmitting, if the device information of the second device is received, first information for authentication of the second device to the second device;
receiving second information for authentication of the second device from the second device;
comparing the first information with the second information; and
registering the second device in association with the first device if the first information corresponds to the second information.

3. A method for registering a device to a server, the method comprising:
connecting a second device to a first device, the first device having been registered to the server;
transmitting, by the second device, device information of the second device to the first device;
receiving first information for authentication of the second device based on the device information of the second device from the server; and
transmitting second information for authentication of the second device to the server if the first information for authentication of the second device is received.
